(19) United States
(12) Patent Application Publication
(10) Pub. No.: US 2015/0184622 A1
(43) Pub. Date: Jul. 2, 2015

(54) Equipment for Structurization and Polarization of Fuel, Combustion Mixture or Water

(71) Applicant: Kamo KUREGYAN, Pyatigorsk (RU)

(72) Inventor: Kamo KUREGYAN, Pyatigorsk (RU)

(21) Appl. No.: 14/645,742

(22) Filed: Mar. 12, 2015

Related U.S. Application Data
(63) Continuation of application No. PCT/IB2012/002851, filed on Sep. 12, 2012.

(51) Int. Cl. F02M 27/04

(52) U.S. Cl. CPC F02M 27/04

(57) ABSTRACT

The invention relates to engine construction, to equipment for improving fuel and combustion mixture. Also may be used for water processing. Economy of fuel and decrease of noxious air emissions in the atmosphere are achieved. Equipment for structurization and polarization of fuel, combustion mixture or water, comprises a body in a form of a hollow cylinder with a smooth inside surface and a rod mounted in the body, both made of current-conducting materials and connectable to the electric circuit. The equipment is supplied with a battery of current-conducting discs interleaved with insulating ones, positioned on the rod. The size of a working gap for passing fuel between the tops of the discs and the body doesn't exceed 1/10 of the size of the working surface of the body. The body and the rod are made of duralumin alloy, but the current-conducting discs of aluminum. The plain surfaces of the current-conducting discs are performed with electro insulating cover, without covering the tops of the discs.

### RELATED APPLICATIONS

This application is a Continuation Application of International Application PCT/IB2012/002851, filed on Sep. 12, 2012, which is incorporated herein by reference in its entirety.

### FIELD OF THE INVENTION

The invention relates to propulsion engineering, specifically to equipment for processing fuel or combustion mixture (fuel with air) and may be used in fuel system of internal combustion engine (ICE). The invention also may be used for processing of drinking water and water for plant irrigation.

### BACKGROUND OF THE INVENTION

There is known a method of processing diesel fuel, carried out by equipment for decreasing toxicity of emissions [Description of invention of patent U.S. Pat. No. 6,178,954 of Jun. 12, 1997, U.S.Cl.123-538, Pub. 30.01.2001]. The method implies processing of fuel stream by means of magnetic field, that makes it possible to align unipolarly charged hydrocarbon molecules in a way such that in a combustion chamber there takes place its more complete dispergation and consequently more complete burning. By means of this the decreased toxicity of emissions is achieved.

The drawback of this method of fuel processing is that by means of magnetic field only a small portion of the total volume of hydrocarbon fractions presented in the fuel could be aligned, although even this amount is enough for achieving a visible effect.

There are known numerous methods and designs employing permanent magnets for structurization and/or polarization of fuel or combustion mixture (see patents of the Russian Federation on inventions and utility models No RU2391551; RU2368796; RU2268388; RU2396454; RU2364792; RU2324838; RU2307258; RU2300008; RU2256815; RU2251018; RU2200246; RU2200245; RU2408792; RU2266427; RU59740; RU52942, applications of the Russian Federation on inventions and utility models X_RU2008100406; RU2004112248; RU2008134540; RU2006112414; RU2004124695; RU2004103245; RU2009140192; RU2009106937; RU2008100599; RU2008100406; RU2006111123; RU2005134706; RU97108172; RU971103743, also patent of Belgium BG64926 and patent of the USA U.S. Pat. No. 5,558,765).

The common drawbacks of these methods and designs are low efficiency, dearness of powerful magnets of rear-earth metals and their short lifetime (about 6 months), as soon as magnets become demagnetized.

It is known a method of processing with electrostatic field, in particular of a motor fuel [see description of British patent GB2295421 of 22.11.1994, IPC6 F02M 27/04 (GB Cl. FIB), Pub. 29.05.1996]. In order to increase level of effects of the electrostatic field the method comprises consecutive processing of the stream in two stages. This hook potentially allows use of this engineering solution on high-speed streams.

It is known a method of indirect effect on fuel in order to provide improved characteristics of its burning, realized by means of mixing fuel with air processed by internal electrostatic and external magnetic fields [See description of German patent DE19681531 of 29.05.1996, IPC6 F02M 27/04, Pub. 04.12.1997].

Electromagnetic processing of fluid supposes weakening of intermolecular interactions (bonds) inside it. When mixing two fluids—processed and unprocessed ones—there happens homogenization of the overall dispersion of the mixture. In the case of the abovementioned invention when mixing processed air with fuel, a combustion mixture dispersion of which is considerably higher than dispersion of the regular mixture is obtained, that appreciably improves performance of engine. Nevertheless, such characteristics, as for example completeness of combustion, are still inefficient.

It is known a method carried out by an equipment processing fuel, mostly for gas-turbine engines, that comprises destruction of hydrocarbon fractions of fuel on account of weakening forces of molecular interaction under the influence of electrostatic and magnetic fields created simultaneously in several places of the stream's cross-section (See description of Russian patent RU2147075 of 19.05.1999, IPC7 F02M 27/04, Pub. 27.03.2000., Bul. No 9].

Despite of the high efficiency of processing providing dispersion of fuel in the combustion chamber almost on molecular level, this method has limited productivity on swift-flowing streams, when the polarized hydrocarbon fractions failed to line up in time, quickly lose their potential.

It is known equipment for processing fuel, comprising a hollow body with a channel for flowing fuel and two concentrically nested one into another tubular electrodes connected to power supply (US patent #3805492, F 02M 27/04, Pub. 1974 prototype).

The said equipment for processing fuel in electric field leads to the reduction of toxicity of the engine. The drawback of the said equipment is the low efficiency, firstly because it processes combustion mixture with water steam, and secondly, because the voltage of the field is low due to the big area of electrodes, also the equipment is complicated for manufacturing and operation.

It is known equipment for fuel processing comprising hollow body with intake and outlet connections, positive electrode positioned on the axis of the body and negative electrode positioned concentrically to the electrode on the external surface of the body in the area of the outlet connection. At this, the body and the outlet connection are made of electro insulating material, but the body from the side of the positive electrode is supplied with dielectric insertion (USSR Author's certificate SU1671934, F 02M 27/04, Pub. 1989).

The drawbacks of this invention consist in complexity of its design due to a large quantity of component parts, and in an insufficient performance due to the low voltage of the field and inability of adjusting a gap between the electrodes, because at a small gap the possibility of discharge on the body is high, but at a large gap—the electric field is unstable.

It is known equipment for processing automotive fuel comprising hollow body with intake and outlet connections, positive electrode mounted on the longitudinal axis of the body and negative electrode positioned concentrically to the positive one on the external surface of the body in the area of the intake connection. At this, the body and the intake connection are made of electro insulating material. The body from the side of the positive electrode is supplied with a dielectric insertion, at this negative electrode is mounted on the body with the possibility of axial movement and is executed in a form of a hub (Patent of the Russian Federation RU227293, F02M 27/04, Pub. 1996).

The drawbacks of the last and the previous equipments consist in complexity of design and low performance due to uniformity of electric field allocation along the longitudinal axis of the body that is functionally unfavorable and decreases polarization and activation of fuel in process.

There are known numerous methods and equipments that affect fuel or air-fuel mixture by means of electromagnetic field or electric charges also together with magnets, while passing fuel or mixture between charged electrodes in order to improve combustibility qualities and to save fuel on the account of structurization at the molecular level and further polarization. After these procedures practically complete combustion of fuel in engine is reached, that increases power-to-weight ratio and brings to naught noxious emissions into the atmosphere (see patents of the Russian Federation on inventions and industrial designs ##RU2396454; RU2335652; RU2330984; RU2300008; RU2296238; RU2278989; RU2310769; RU2270355; RU2269025; RU2221153; RU2215172; RU18742; RU107292; RU100564; RU46310; RU80512; RU77356; RU52942; RU52116; RU44151; RU43922; RU76393; RU69575; RU69574, applications on inventions and industrial designs ##RU2004124695; RU2010138760; RU2009140192; RU2008101844; RU2008100599; RU2007122073; RU2006100023; RU2010117738; RU93044659; RU92007417; RU92002011; RU92011766; RU97104985; RU97103235; RU97102417; RU96118123; RU96112333; RU95120426; RU95118617, also patent of China CN202091064 and application on patent CN101368531, applications on US patent US2004238514, German—DE333722 and European—EP1209346).

It is also known equipment for processing fluid and/or gaseous medium according to application on the Russian Federation patent RU95114110. The last is named as a prototype, because it is the most close to the claimed invention according to essential design features. The prototype comprises body made of dielectric material with intake and outlet connections, high voltage power source connected with an extended positive electrode placed inside the body and creating between the inner surface of the body and the positive electrode a processing cavity interconnecting with the intake and the outlet connections, and also comprising a negative electrode grounded and mounted outside the body opposite the processing cavity. Positive electrode is executed with claws, allocated along the whole length of the electrode perpendicularly to its axis.

The methods and equipment listed above without a doubt fairly achieve activation of fuel, improvement of its capacity to mix with air oxygen and better, nearly 100% combustion, as a result of structurization on molecular level and polarization of electric dipoles of molecules. However the common drawback of all the listed methods and equipments, inclusive the prototype, consists in considerable energy consumption for structurization and polarization of fuel. Thus, one can't recognize a significant fuel economy, because in an automobile, for example, this energy is consumed from battery charged from internal combustion engine consuming the same fuel. This drawback is caused by shortcoming of design. Bewaring of breakdown between electrodes, chambers for processing flowing fuel in the equipment known from the background art are made of significant sizes that requires to apply more power for permeating them with electric field. Therefore the main gain—any considerable economy of fuel is not actually achieved.

### SUMMARY OF THE INVENTION

The target of the claimed invention is to provide the most cheap and lasting equipment for fuel economy, increase of power and minimization of noxious emissions while applied in internal combustion engines, but when used for improvement of water qualities—to achieve more efficiency at minimal electrical energy consumption.

### DISCLOSURE OF THE INVENTION

On the molecular level fuel represents abundance of clusters in which molecules are bounded in a specific way. During the usual combustion only 50-60% of molecules in a cluster manage to burn that lowers fuel efficiency.

As it is known, in combustion engines fuel economy may be achieved due to structurization of fuel on molecular level. Such an impact provides increased engine power, fuel economy, decreased toxic level of emissions, and prolonged life of oil and engine parts.

In order to achieve complete burn of fuel it is necessary to break these clusters and put the molecules into order. Right this could be achieved by means of fuel structurization.

Hydrocarbons in fuel have a structure “like a closed cage”. That is why oxygenation of internal carbon atoms is inaccessible for combustion process. Also, any fuel, no matter where kept, constantly experiences change due to temperature and humidity influence. Such an influence makes fuel to expand and constrict. On the whole, hydrocarbon molecules start to gravitate and thus create molecule groups—“molecule bunches”. Such “bunches” form chains. Access of oxygen inside created chains is confined that is a reason of incomplete burning of fuel regardless of amount of air flowing from collector. Complete burning will not take place even in case of oversupply. The reason is that oxygen is unable to reach groups of atoms inside the chain. For complete burning of such a chain it is necessary either to provide access of oxygen inside it or to break the chain on separate molecules. When the hydrocarbon fuel ignites, firstly the atom of hydrogen (outer electrons) oxidizes, and only after that the carbon atoms burn. If the internal combustion process is swift-passing it needs more time to oxidize all atoms of hydrogen, i.e. only a part of carbon oxidizes. Incompletely burnt fuel molecules produce emission. Oxygen aggregates hydrogen instantly, but reaction of carbon oxygen is less vigorous—we should take in account that valency (oxidation state) of oxygen is always minus two. On the other hand, valency (oxidation state) of carbon may be plus or minus, depending on configuration of its four electrons on the outer shell that requires eight electrons for completion. Variation of outer shell spin alters the activity of fuel. More excited spin-state of hydrogen molecule significantly increases activity that allows attracting additional oxygen. Developers of combustion systems teach that additional oxygen saturation of fuel increases combustion efficiency. Therefore altering spin-state of molecule, increasing its magnetic moment we increase activity of hydrocarbon thereby improving quality of fuel combustion process. The applied equipment charges fuel molecules, dispersing at that created bunches of fuel molecules into separate molecules that significantly increases attraction of negatively charges oxygen molecules and facilitates complete fuel combustion.

Optimal combustion efficiency achieved by means of the claimed invention is marked by increased emission of carbon dioxide (CO2) that may be measured by emission control equipment (gas-analyzer). Simultaneously to decreased emission of CO, CH and NOx, the fuel combustion efficiency increases. Decreased emission of CO, CH and NOx takes place immediately after installation of the equipment. One can make sure by measuring noxious emissions by means of gas analyzer. Maximal combustion efficiency is achieved at getting finally CO2 (carbon dioxide), because CO2 could not be further oxidized.

The possibility of improvement of combustion fluids by means of electrical processing and physics of these processes are known for a long time. The whole class is devoted to them in the International Patent Classification and there exist numerous methods and designs, for example, listed in the background art. Scientific literature on this subject:—Ref: Scientific American—by Neil Gershenfeld Ph.D. and Lsaac L. Chuang Ph.D. June 98;
Further reading: The hydrogen atom in a uniform magnetic field: An example of chaos/resonance. Harald Friedrich and Dieter Wintgen in Physics Reports, Vol. 183, No. 2, pages 37-79 November 1989;
Bulk Spin Resonance N. A. Gershenfeld and I. L. Chuang in Science, Vol. 275, pages 350-356; Jan. 17, 1997;
Principles of Magnetic Resonance. Third edition. Charles P. Slichter. Springer-Verlag, 1992.

Regarding electric conductivity it is known that electric resistivity of inflammable fluids is so high that all fluid inflammable materials without exception are excellent electrical insulators, i.e. do not pass current and therefore are electrically non-processable, but electro polarizable. Electro polarization properties of materials mostly depend on electric dipole moment of materials and all inflammable fluids are materials polarizable in the magnetic field. The same is water. Electro polarization properties of fluids depend on structure of their molecules, each of them being a kind of micro-electro-dipole.

The target goal in the equipment for structurization and polarization comprising supply and discharge channels, a body in a form of a hollow cylinder, and a rod mounted in the body centrally and straightened by means of a leak proof insulation spacer, where both the body and the rod are made of current-conducting materials, and with a means for connection to the electric circuit, is achieved due to the presence of the following distinguishing features according to the claimed invention:
the equipment is supplied with a battery of current-conducting discs interleaved with insulating ones, tightly positioned on the rod, wherein, along with that the shape of the tops of the discs is similar to the shape of the internal surface of the body, but is less in dimensions, as well as are the shape and the dimensions of the insulating discs in comparison with the current-conducting ones, the size of a working gap for passing fuel, combustion mixture or water, created between the top of any current-conducting disc and the internal surface of the body doesn't exceed 1/10 of the average size of the working surface of the body in the given cross-section and at the same time doesn't exceed the difference between the tops of the given current-conducting and adjoined insulating discs, measured in the same radial direction of the same cross-section, but the thickness of any current-conducting disc is less than the thickness of adjoined to it insulating one;
the body in the quality of cathode is connected to the negative charge, but the rod with the battery of current-conducting discs in the quality of anode to the positive charge of the current circuit;
the body and the rod with the flange are made of duralumin alloy, the current-conducting discs of aluminum, but the insulating discs of dielectric material resistant against oil and petrol;
the working gap between the internal surface of the body and the tops of the current-conducting discs is performed in the range of 1-50 mm, the thickness of the current-conducting discs—in the range of 0.01-3 mm, the thickness of the insulating discs—in the range of 0.05-100 mm, but the difference between the dimensions of the tops of the current-conducting and the insulating discs is performed in the range of 1-50 mm;
the plain surfaces of the current-conducting discs are performed with electro insulating cover, without covering the tops of the discs.

There is a cause-effect connection between the distinctive features of the claimed invention and achieved results.

In the claimed equipment there is a system of electrodes creating quasi-steady heterogeneous electric field that provides:

high electric field intensity in the space between the electrodes without loss;

strong heterogeneity of electric field between the electrodes having growth trend from one electrode to another;

enough duration of stay between electrodes (starting from the moment of entering fluid in the sphere of electric field action and up to exit from the equipment) for each portion of inflammable fluid;

possibility of additional installation of voltage and current load (for engines consuming a great amount of fuel) regulators in the electric chain.

Besides this, in the claimed equipment:

it is chosen such a ratio of gaps between the cathode (internal surface of the body) and the anode (tops of current conducting disks) towards their dimensions, that influence of the electric field on passing fluid is at most intensive at minimal energy spend;

the influence takes place step-by-step and repeatedly because of presence of the battery of current conducting disks;

after passing each disk, in the cavities there takes place “curling effect”, appears stream turbulence and forced electrical convection of fluid. Due to difference between the diameters of anode aluminum disk and anode insulation appears curling of fluid that leads to structurization and preparation for polarization by electric field;

energy rings radiate from cuts of aluminum disks towards the cathode, structure fluid and polarize its molecules;

an “effect of needlepoint” takes place—passing on the surface of sharp cuts of aluminum disks, fluid molecules break up into atoms.

All these measures in the design of the equipment for processing fuel for internal combustion engine provide reasonable degree of fuel isometrics, i.e. of hydrocarbon atom-molecule system branching, structured and polarized fluid becomes more active, like “alive”, better conceives oxygen and burns completely what we do need.

The claimed aggregation of the known and distinguishing features according to the sources known to the applicant is not known from the art yet. Also distinguishing design features differ from the features of the known equipment so much that in author's opinion do not follow clearly from the background art. Therefore according to author the claimed equipment satisfies criteria of novelty and invention step.

### BRIEF DESCRIPTION OF THE DRAWINGS

FIG. 1 shows the longitudinal section of the claimed equipment;

FIG. 2 shows the cross-section of the embodiment with cylindrical body;

FIG. 3 shows the cross-section of the embodiment with prismatic body; and

FIG. 4 shows the scheme of fuel, combustion mixture or water flow along the tops of the discs.

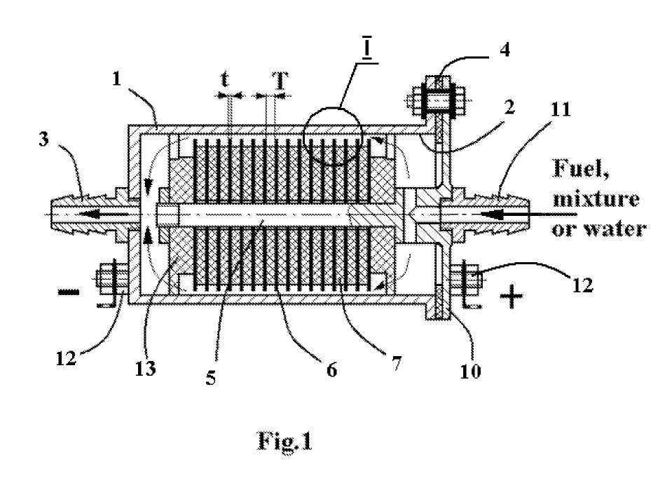

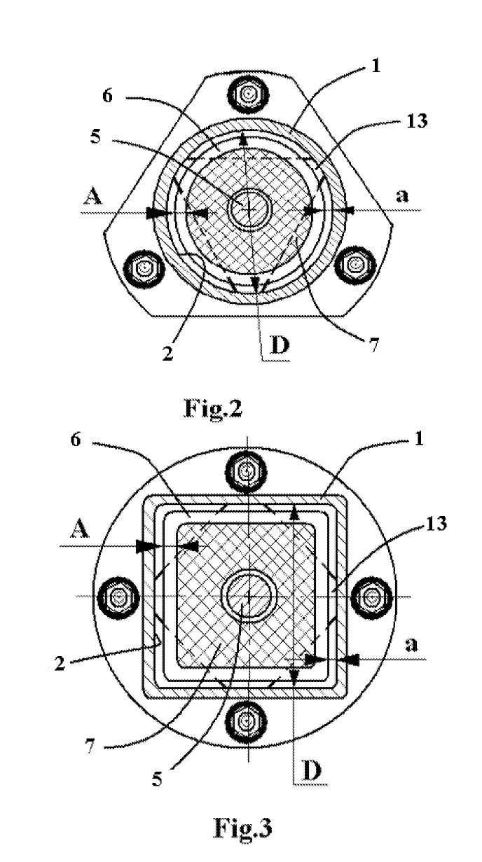

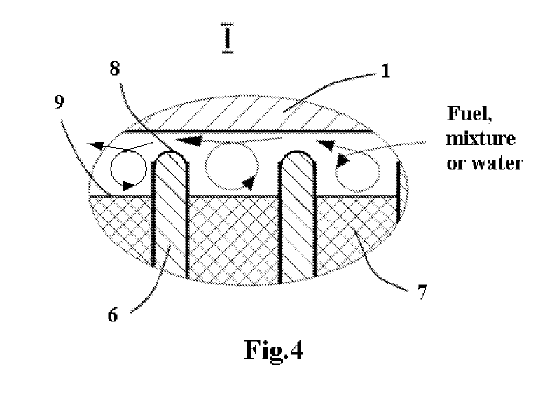

### DETAILED DESCRIPTION OF THE PREFERRED EMBODIMENTS

The equipment comprises body 1 (cathode) representing a hollow cylindrical pipe with a smooth inside surface 2 made of all-metal cylinder. In the back part the cylindrical pipe passes into molded bottom with outlet connection 3. The body 1 is produced of duralumin alloy under the high pressure and after that is processed on machines with numerical program control. The body 1 could be executed not necessarily with a round cross-section, but, for example, with oval or prismatic, but such embodiments are less processable. In the cut face part body 1 has attaching points and place for insulation spacer 4. Body 1 also plays role of electromagnetic shielding for insulation and protection of other equipment from electromagnetic disturbances.

The anode of the equipment is executed in a form of a rod 5 on which there are mounted alternately current conductive aluminum discs 6 with thickness “t” from 1.10 to 3 mm (depending on capacity of engine and equipment), and also dielectric insulating discs 7 with thickness “T” from 0.05 to 100 mm (depending on capacity of engine and equipment).

Plain surfaces of aluminum disks 6 are covered with electro insulating cover. Cuts of tops 8 of aluminum disks 6 have an even circuit and conduct current.

The internal opening of aluminum disk 6 has diameter 0.01-0.05 mm less than diameter of the anode rod 5. It is necessary for tight adjoining of contact area of disk 6 and the rod 5.

The internal opening of the insulating disk 7 has diameter bigger than the rod for handy assemble with spacing on works.

Gap “a” between the tops 8 of aluminum disks 6 and internal surface 2 (cathode) of body 1 has size from 1 to 50 mm (depending on capacity of the equipment). At this, the said gap is to be not less than 10 times smaller than size “D” (diameter or distance between internal facets of prism) of the internal surface 2 of body 1.

Radius of tops 8 of aluminum disk 6 exceeds radius of tops 9 of insulating disk 7 on drop “A” equal to 1-50 mm (depending on capacity of the equipment). A thread is cut on the rod for a screw tightening anode disks 6 and insulating disks 7.

On the rod 5 there is a toe with ports for passing fuel. The rod 5, its toe and side flange 10 are molded of duralumin alloy under high pressure and afterwards processed on machines with numerical program control. On the flange part 10 of the rod a connection 11 for supply of processing fluid is arranged.

The rod 5 by its flange part 10 is attached via spacer to the body 1.

Spacer 4 between body 1 and flange 10 of the rod 5 are made of dielectric oil and petrol resistant paronite having thickness from 2 to 10 mm.

Holes for fixing body 1 to flange 10 are supplied with dielectric plugs (of kaprolon) having end plane for their insulation from fixing ring-screw and bolt.

On the body 1 and flange 10 of the rod 5 terminals 12 are installed and connected to the power supply.

Centering plugs 13 serve for exact centering of the rod 5 in the body 1 at assemble.

The amount of currency conducting anode disks 6 depends on fuel consumption y engine and may vary from 5 to 1000 pieces and more.

Operating voltage of the equipment may vary from 12 to 500V, but current load range from 1 to 200 A.

The equipment for structurization and polarization of fluid (fuel, combustion mixture or water) operates in the following way.

Fluid (or combustion mixture) forcedly (under pressure or by gravity) enters into the equipment via inlet connection 11 and port in the rod 5. Then it flows through circular gap between the internal surface 2 of the body 1 and current conducting disks 6 towards the outlet connection 3 and leaves equipment for further usage. At this, body 1 and disks 6 are under voltage—body 1 under negative, but disks 6 under positive charge. In the said gap between the tops 8 of disks 6 and body 1 acts electric field, that affects passing stream of fluid or mixture.

Passing in the said field fluid (or mixture) repeatedly experiences the following:

while passing over each top of disks 6 the stream mechanically curls, gets turbulence that promotes better molecule structurization and polarization;

under the influence of electric field the stream passing through lines of electric field directed from the tops 8 of disks 6 towards the body 1, becomes more and more structurized and polarized. Thus the molecule structure becomes more homogeneous for better further oxygen “assimilation” (for its better access to the hydrogen and carbon atoms comprised in fuel) during detonation and burning. At this, while passing tops of charged disks, the atom spins are more and more aligned in ordered direction, i.e. are polarized. Such arrangement of spins is unnatural and atoms try to return in original state, that makes fuel or mixture (or water) more active for better combustion or for effective employment (for example of water for irrigation or for drinking).

As a result the complete burning, decreased noxious emissions, increased efficiency of internal combustion engine and save of fuel consumption are achieved. Water becomes more wholesome.

The author has produced and tested several standard sizes of experimental samples of the claimed equipment.

Sample 1. Equipment for automobiles consuming petrol. Number of aluminum anode disks—14 ps. with inter-disk gap 3.5 mm and gap between the body and tops of the disks—2 mm. At voltage 12 V, current load 20A and stream pressure 3 atm, fuel consumption in the automobile with this equipment was reduced on 17.5% (confirmed by independent examination).

Sample 2. Equipment for automobiles consuming petrol. Number of aluminum anode disks—15 ps. with inter-disk gap 3.5 mm and gap between the body and tops of the disks—2 mm. At voltage 12 V, current load 20A and stream pressure 3 atm, fuel consumption in the automobile with this equipment was reduced on 16% (confirmed by independent examination).

Sample 3. Equipment for automobiles consuming petrol. Number of aluminum anode disks—16 ps. with inter-disk gap 3.5 mm and gap between the body and tops of the disks—2 mm. At voltage 12 V, current load 20A and stream pressure 3 atm, fuel consumption in the automobile with this equipment was reduced on 14.5% (confirmed by independent examination).

Sample 4. Equipment for automobiles consuming petrol. Number of aluminum anode disks—18 ps. with inter-disk gap 3.5 mm and gap between the body and tops of the disks—2 mm. At voltage 12 V, current load 20A and stream pressure 3 atm, fuel consumption in the automobile with this equipment was reduced on 12.5% (confirmed by independent examination).

Sample 5. Equipment for automobiles consuming petrol. Number of aluminum anode disks—20 ps. with inter-disk gap 3.5 mm and gap between the body and tops of the disks—2 mm. At voltage 12 V, current load 20A and stream pressure 3 atm, fuel consumption in the automobile with this equipment was reduced on 10.5% (confirmed by independent examination).

Sample 6. Equipment for automobiles consuming petrol. Number of aluminum anode disks—24 ps. with inter-disk gap 3.5 mm and gap between the body and tops of the disks—2 mm. At voltage 12 V, current load 20A and stream pressure 3 atm, fuel consumption in the automobile with this equipment was reduced on 8.5% (confirmed by independent examination).

Sample 7. Equipment for automobiles consuming petrol. Number of aluminum anode disks—24 ps. with inter-disk gap 3.5 mm and gap between the body and tops of the disks—2 mm. At voltage 24 V, current load 60A and stream pressure 3 atm, fuel consumption in the automobile with this equipment was reduced on 17.5% (confirmed by independent examination).

The listed examples enable to make conclusion that increase of number of disks gives effect only providing increased voltage and the main thing current load too.

Maximal achievable value of fuel economy could reach 25-30%. At this 25-45% (depending on engine type) decrease of noxious emissions in the atmosphere is achieved and engine capacity improvement is present.

The equipment is processable, easy in serial production and may be inexpensive.

Lifetime of the equipment is practically unlimited, rarely may need only washing.

What is claimed is:

1. Equipment for structurization and polarization of fuel, combustion mixture or water, comprising:
supply and discharge channels, a body in a form of a hollow cylinder, or a prism, or a frustum of pyramid, or a glass, with a smooth inside surface, and a rod mounted in the body equidistantly or centrally and straightened with a flange by means of a leak proof insulation spacer, wherein both the body and the rod are made of current-conducting materials and are connectable to the electric circuit;
a battery of current-conducting discs interleaved with insulating disks, tightly positioned on the rod, wherein a shape of the tops of the discs is similar to that of the internal surface of the body, but is smaller in dimensions, and a shape of the tops of the insulating discs is similar to that of the current-conducting ones, but is smaller in dimensions; and
a working gap for passing fuel, combustion mixture or water, formed between the top of any current-conducting disc and an internal surface of the body, a size of the working gap not exceeding 1/10 of an average size of the working surface of the body in a given cross-section, and the size of the working gap not exceeding a difference between the tops of a current-conducting disk and an adjoining insulating disc, measured in a same radial direction of a same cross-section, wherein a thickness of any current-conducting disc is less than that of an adjoining insulating disk.

2. The equipment according to claim 1, wherein the body serving as a cathode is connected to a negative charge and the rod with the battery of current-conducting discs serving as an anode is connected to a positive charge of the current circuit.

3. The equipment according to claim 1, wherein the body and the rod with the flange are made of duralumin alloy, the current-conducting discs are made of aluminum, and the insulating discs of are made of dielectric material resistant to oil and petrol.

4. The equipment according to claim 1, wherein the size of the working gap between the internal surface of the body and the tops of the current-conducting discs is in the range of 1-50 mm, the thickness of the current-conducting discs is in the range of 0.01-3 mm, the thickness of the insulating discs is in the range of 0.05-100 mm, and the difference between the dimensions of the tops of the current-conducting and the insulating discs is in the range of 1-50 mm.

5. The equipment according to claim 1, plain surfaces of the current-conducting discs comprise an electro insulating cover, the electro insulating cover not covering the tops of the discs.
